(19) United States
(12) Patent Application Publication
(10) Pub. No.: US 2017/0151126 A1
(43) Pub. Date: Jun. 1, 2017

(54) BICYCLE SADDLE HAVING ACUPRESSURE AND MASSAGE FUNCTIONS

(71) Applicant: Dae Sig KONG, Seongnam-si (KR)

(72) Inventor: Dae Sig KONG, Seongnam-si (KR)

(21) Appl. No.: 15/429,182

(22) Filed: Feb. 10, 2017

Related U.S. Application Data
(63) Continuation of application No. PCT/KR2015/006115, filed on Jun. 17, 2015.

(30) Foreign Application Priority Data
Aug. 11, 2014 (KR) 20-2014-0005995
Sep. 5, 2014 (KR) 20-2014-0006619

(51) Int. Cl. A61H 39/04; B62J 1/00; A61H 7/00; A61H 19/00; A61H 15/00

(52) U.S. Cl. CPC A61H 39/04; A61H 19/00; A61H 15/00; A61H 7/002; B62J 1/007; A61H 2203/0425

(57) ABSTRACT

Disclosed is a bicycle saddle having perineal acupressure and massage functions. The bicycle saddle, which is installed on a bicycle, includes: a saddle main body to support left and right buttocks of a rider; and a massage member rotatably installed at a front end portion of the saddle main body so as to contact a perineal region of the rider according to pedaling of the rider and thus, while rotating, stimulate the perineal region of the rider, thereby providing acupressure and massage effects thereon. In such a configuration, when the rider pedals, the massage member stimulates the perineal region of the rider while alternately rotating leftward and rightward, thereby providing acupressure and massage effects thereon.

### CROSS-REFERENCES TO RELATED APPLICATIONS

This Application claims the benefit of priority and is a Continuation application of the prior International Patent Application No. PCT/KR2015/006115, with an international filing date of Jun. 17, 2015, which designated the United States, and is related to the Korean Patent Application No. 10-2014-0005995, filed Aug. 11, 2014 and the Korean Patent Application No. 10-2014-0006619, filed Sep. 5, 2014, the entire disclosures of all applications are expressly incorporated by reference in their entirety herein.

### BACKGROUND OF THE INVENTION

1. Field of the Invention

The present invention relates to a bicycle saddle, and more particularly to a bicycle saddle having a perineal massage function.

2. Description of Related Art

Generally, in apparatuses for removing a foreign substance included in a raw In recent years, in line with the “well-being” craze to live a leisurely and pleasant life, there has been growing interest in exercise to lead a healthy life. Accordingly, exercise using a bicycle has recently become popular.

Most bicycles are two-wheeled bicycles with wheels rotated by pedal movement, and such two-wheeled bicycles are used for outdoor exercise. Additionally, bicycles for indoor exercise, not including wheels and provided with loading members at pedals thereof to enable bicycle pedaling exercise indoors such as in gyms or at home, are widely used.

However, such bicycles have problems in that, when a user pedals while riding on a saddle, the user only does lower body exercise, not upper body exercise, and the perineal region and genitals of the user closely contact the saddle, resulting in poor blood circulation.

Thus, to address such poor blood circulation, a prostate protection saddle, provided with grooves or a concave valley at a contact portion between the saddle and the scrotum and genitals, has been proposed to improve blood circulation. However, there is still room for improvement.

### BRIEF SUMMARY OF THE INVENTION

Therefore, the present invention has been made in view of the above problems, and it is one object of the present invention to provide a bicycle saddle that has a simple structure and acupressure and massage functions on the perineal region and genitals according to pedaling movement and thus improves blood circulation, resulting in health promotion.

In accordance with one aspect of the present invention, provided is a bicycle saddle having perineal acupressure and massage functions and installed on bicycles, including: a saddle main body to support left and right buttocks of a rider; and a massage member rotatably installed at a front end portion of the saddle main body so as to contact a perineal region of the rider according to pedaling of the rider and thus, while rotating, stimulate the perineal region of the rider, thereby providing acupressure and massage effects thereon.

The massage member may include: a rotary body provided with a rotary shaft at one side thereof and rotatably installed in a state in which the rotary shaft is inserted into the front end portion of the saddle main body; and a plurality of massage projections protruding from an outer circumferential surface of the rotary body.

The massage member may include: a rotary body provided with a rotary shaft at one side thereof, rotatably installed in a state in which the rotary shaft is inserted into the front end portion of the saddle main body, and including a pair of circular plates separated from each other and a connection rod connecting centers of the circular plates; a plurality of wires connecting edges of the circular plates to each other, spaced apart from each other along circumferences thereof, and having elastic force; and a plurality of massage projections into which the wires are inserted to be rotatable about the wires.

The saddle main body may be provided, at the front end portion thereof, with a rotary shaft hole into which the rotary shaft is inserted, and the rotary shaft is provided, at an end thereof, with a cutting groove formed in a length direction to be divided into two branches, the end of the rotary shaft being provided, at an outer circumferential surface thereof, with an escape prevention member protruding therefrom.

In accordance with another aspect of the present invention, provided is a bicycle saddle having perineal acupressure and massage functions and installed on indoor and outdoor bicycles, including: a saddle main body including a buttock supporting part to support left and right buttocks of a rider and an extension part extending from a front end of the buttock support part; a plurality of seating grooves in the saddle main body; and massage projections accommodated and rotatably installed in the seating grooves and partially protruding from the saddle main body so as to contact a perineal region of the rider according to pedaling of the rider and thus, while rotating, stimulate the perineal region of the rider, thereby providing acupressure and massage effects thereon.

The massage projections may be rotatable about a rotary pin installed in the seating grooves.

The massage projections may be formed as ball members having a spherical shape and rotatably installed in a state of being accommodated in the seating grooves.

In accordance with another aspect of the present invention, provided is a bicycle saddle having perineal acupressure and massage functions and installed on indoor and outdoor bicycles, including: a saddle main body including a buttock supporting part to support left and right buttocks of a rider and an extension part extending from a front end of the buttock support part; a convex part disposed at a central portion of the saddle main body to protrude therefrom and having a hemispherical shape; a plurality of seating grooves formed in the convex part; and massage projections accommodated and rotatably installed in the seating grooves and partially protruding from the extension part so as to contact a perineal region of the rider according to pedaling of the rider and thus, while rotating, stimulate the perineal region of the rider, thereby providing a massage effect thereon.

The massage projections may have any one shape selected from a circular shape, a star shape, and a triangular shape.

As is apparent from the fore-going description, the present invention advantageously provides a bicycle saddle that provides acupressure and massage functions on the perineal region and genitals of a rider when the rider pedals a bicycle, thereby providing existing aerobic exercise and lower body training effects, providing a perineal health promotion effect, and providing prostate health according to massage of the perineal region, resulting in a sexual function improvement effect and a prostate health promotion effect. In addition, when a rider shakes the pelvis and opposite sides of the upper body while pedaling a bicycle so as to massage the perineal region, an upper body exercise effect may also be obtained.

In addition, in existing bicycle saddles, genitals of men, i.e., the scrotum and the perineal region, closely contact the bicycle saddle and are pressed due to the body weight of a rider, thus hindering blood circulation. A bicycle saddle according to the present invention has a massage function when a rider pedals a bicycle and thus may provide a smooth blood circulation effect and have an effect of strengthening the pelvis and genital muscles in women.

In addition, the bicycle saddle of the present invention also massages muscles around the anus and thus provides a smooth blood circulation effect around the anus, thereby having an effect of helping prevention of various anus-related diseases such as hemorrhoids and the like. Moreover, the bicycle saddle of the present invention has a massage effect on the scrotum, which is a genital organ of men.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a bicycle saddle having a perineal massage function according to a first embodiment of the present invention;

FIG. 2 is a combined perspective view of the bicycle saddle having a perineal massage function according to the first embodiment of the present invention;

FIGS. 3A and 3B are enlarged views of an essential part of FIG. 1, wherein FIG. 3A illustrates a state in which a rotary shaft is separated from a rotary shaft hole, and FIG. 3B illustrates a state in which the rotary shaft is inserted into the rotary shaft hole;

FIG. 4 is a perspective view of a massage member of a bicycle saddle having a perineal massage function according to a second embodiment of the present invention;

FIG. 5 is a cross-sectional view of FIG. 4;

FIG. 6 is a perspective view of a bicycle saddle having a perineal massage function according to a third embodiment of the present invention;

FIG. 7 is a cross-sectional view of an essential part of FIG. 6;

FIG. 8 is a cross-sectional view illustrating another example of massage projections illustrated in FIG. 6;

FIG. 9 is a perspective view of a bicycle saddle having a perineal massage function according to a fourth embodiment of the present invention; and

FIG. 10 is a schematic view of a cross-section of the bicycle saddle of FIG. 9.

### DETAILED DESCRIPTION OF THE INVENTION

The above-described goals, characteristics, and advantages of the present invention will be easily understood from exemplary embodiments set forth herein with reference to the accompanying drawings. However, it will be well understood by those of ordinary skill in the art that the present invention is not limited to the embodiments set forth herein and may be embodied in many different forms.

Hereinafter, embodiments of the present invention will be described in detail with reference to the accompanying drawings. In describing the following particular embodiments, many characteristic details are provided for illustrative purposes and clear understanding of the present invention. In addition, a detailed description of elements well known in the art and irrelevant to the present invention will not be provided herein so as not to obscure the invention.

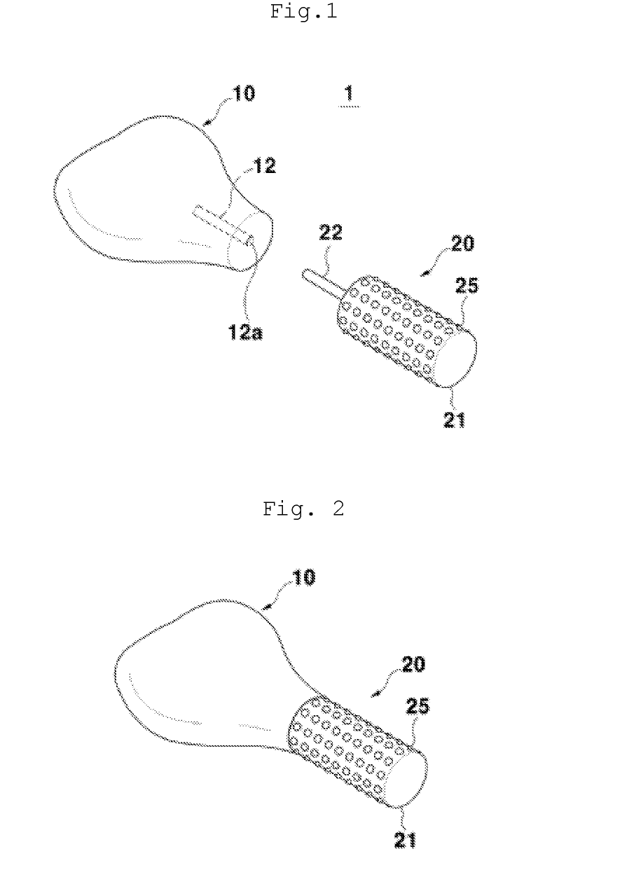

Referring to FIGS. 1 to 3, a bicycle saddle 1 having a perineal massage function according to a first embodiment of the present invention will now be described.

In the present embodiments, the bicycle saddle refers to a bicycle saddle installed on indoor and outdoor bicycles and may be applied to any outdoor or indoor bicycle, such as a two-wheeled bicycle or an exercise bike. In addition, the bicycle saddle according to the present invention may be applied to any kinds of saddles enabling pedaling movements.

The bicycle saddle 1 is a saddle having acupressure and massage effects on the perineal region according to pedaling movement, unlike an existing prostate protection saddle partially recessed so as not to contact the perineal region and genitals.

The bicycle saddle 1 includes a saddle main body 10 and a massage member 20.

The saddle main body 10 supports opposite buttocks of a rider and a front end portion thereof is formed slightly shorter than that of a general bicycle saddle. However, the saddle main body 10 is not limited to the above example and may be configured in various forms so long as it can support opposite buttocks of a rider.

The massage member 20 includes a rotary body 21 and massage projections 25.

The rotary body 21 has a cylindrical shape and is provided with a rotary shaft 22 at one side thereof. The rotary body 21 is rotatably installed at the saddle main body 10 such that the rotary shaft 22 is inserted into a rotary shaft hole 12 formed at the front end portion of the saddle main body 10.

The massage projections 25 protrude from an outer circumferential surface of the rotary body 21. In this regard, the massage projections 25 have a spherical shape, but the shape thereof is not limited thereto. For example, the massage projections 25 may be provided with other protrusions having a star or triangular shape to raise a degree of stimulation. In addition, the massage projections 25 may have any shape so long as they are disposed at the rotary body 21 and can stimulate the perineal region.

The massage projections 25 are made of reinforced plastic as a main raw material and use a metal such as gold, silver, copper, or iron and various natural stones to add a health promotion function thereto, thereby providing a variety of visual designs and helping perineal acupressure and massage functions and stimulating energy circulation.

Meanwhile, the massage member 20 may be rotatably installed at the saddle main body 10 in an integrated form, but the present invention is not limited thereto. For example, the massage member 20 may be detachably installed at the saddle main body 10.

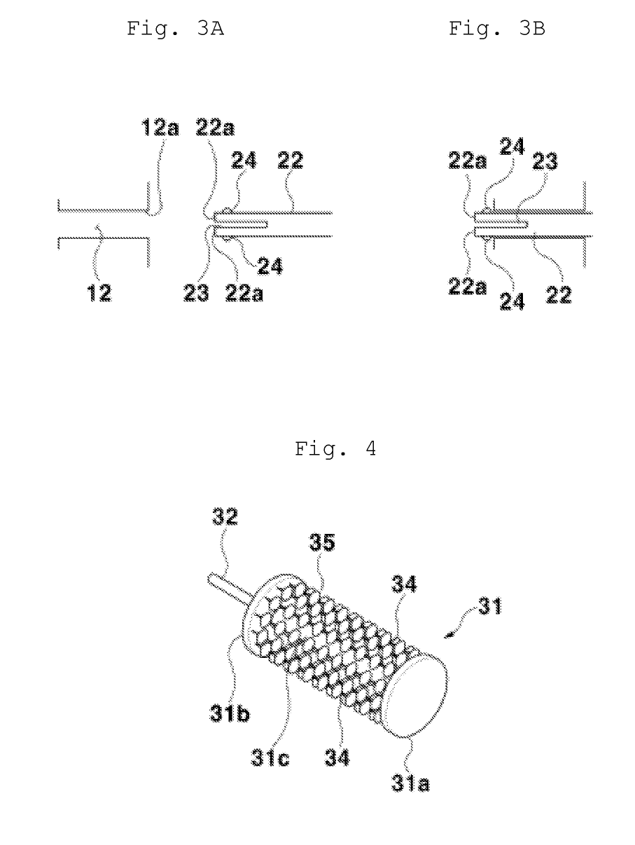

Referring to FIG. 3, the rotary shaft 22 is provided, at an end thereof, with a cutting groove 23 formed in a length direction to be divided into two branches 22a, and each branch 22a is provided, at an outer side thereof, with an escape prevention projection 24 protruding therefrom. As illustrated in FIG. 3A, in a state in which the rotary shaft 22 and the rotary axis hole 12 are separated from each other, when a user pushes the end of the rotary shaft 22 via an entrance 12a of the rotary shaft hole 12, a distance between the two branches 22a becomes smaller and, at the same time, the escape prevention projections 24 start to be inserted into the rotary shaft hole 12 and, when the rotary shaft 22 passes through the rotary axis hole 12 and then escapes from inner lateral ends of the rotary shaft hole 12, the two branches 22a are elastically restored to the original state, thereby completing installation of the massage member 20 at the saddle main body 10 (See FIG. 3B). In this regard, the escape prevention members 24 are stuck in the inner lateral ends of the rotary shaft hole 12 and thus the rotary shaft 22 does not escape from the rotary shaft hole 12 unless external force is applied thereto.

Meanwhile, when a user pulls the massage member 20 from the saddle main body 10, in the state as illustrated in FIG. 3B, the two branches 22a become narrower and the escape prevention members 24 pass through the rotary shaft hole 12, thereby separating the massage member 20 from the saddle main body 10.

In the bicycle saddle 1 of the present invention having the above configuration, when left and right thighs of a user alternately move upward and downward through pedaling movement of bicycle pedals in a state in which the user is seated on the bicycle saddle 1, the perineal region of a rider contacts the massage projections 25 of the massage member 20 and thus the rotary shaft 21 of the massage member 20 alternately rotates leftward and rightward and, accordingly, the massage projections 25 stimulate the perineal region and thus have a massage effect thereon.

In this regard, to raise the perineal massage effect, a rider may pedal while strongly shaking the pelvis and opposite sides of an upper body leftward and rightward.

In this case, the rider has exercise effects of strongly shaking the pelvis and the opposite sides of an upper body leftward and rightward and thus may have both a perineal massage effect and an upper body exercise effect that are not provided by existing bicycle exercises. In addition, the bicycle saddle 1 has a muscle massage effect around the anus and thus stimulates blood circulation around the anus, thereby preventing various anus-related diseases such as hemorrhoids and the like.

Moreover, to obtain a more effective perineal massage effect by using the bicycle saddle of the present invention, the saddle main body 10 is adjusted to have as large a height as possible from a bicycle frame, and thus, when the pedals are set to reach ends of front portions of the feet of a user, in a state of being installed at the lowest position, a leg stretches in order for a pedal to reach a middle portion of a foot and a buttock, pelvis and upper body side on the same side of the leg move downward while twisting towards the simultaneously stretched leg, and a buttock, pelvis, and upper body side on the opposite side move upward while twisting towards the stretched leg. Accordingly, perineal massage efficiency may be enhanced due to friction between the perineal region and the massage projections 25 of the rotary body 21 naturally contacting the perineal region.

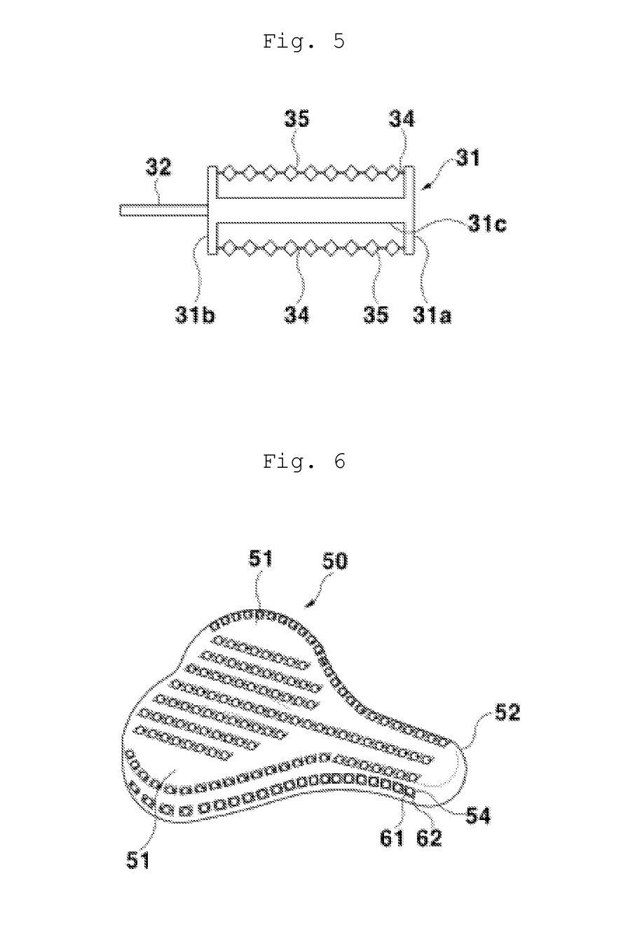

Hereinafter, a bicycle saddle having a perineal massage function according to a second embodiment of the present invention will be described with reference to FIGS. 4 and 5.

The massage member 20 according to the first embodiment has been described as including the rotary body 21 having a cylindrical shape and the massage projections 25 protruding from the outer circumferential surface of the rotary body 21. As illustrated in FIGS. 4 and 5, in the bicycle saddle according to the second embodiment, the configuration of the saddle main body is the same as that in the first embodiment, and a shape of a massage member is different from that in the first embodiment, and thus, only the element different from that in the first embodiment will be described in detail and a detailed description of the element having the same configuration will not be provided herein.

In the bicycle saddle according to the second embodiment, a massage member 30 includes a rotary body 31, wires 34, and massage projections 35.

The rotary body 31 includes two circular plates 31a and 31b spaced apart from each other and a connection rod connecting the centers of the two circular plates 31a and 31b. A rotary shaft 32 is installed at one side of the rotary body 31, i.e., on an outer side of the center of one circular plate 31a of the two circular plates 31a and 31b. The rotary shaft 32 may have the same configuration as that of the rotary shaft illustrated in FIG. 3.

The wires 34 are configured so as to connect edges of the two circular plates 31a and 31b to each other and are spaced apart from each other along circumferences of the two circular plates 31a and 31b . The wires 34 are tightened so as to have tension and thus has a predetermined elastic force.

The massage projections 35 are rotatably installed at each wire 34 such that the wire 34 is inserted into the massage projections 35 to penetrate the same.

In a state in which the massage member 30 according to the second embodiment is rotatably coupled to the saddle main body 10 by the above-described configuration, when left and right thighs alternately move upward and downward through pedaling movement after a rider is seated on the bicycle saddle, the perineal region of the rider contacts the massage projections 35 of the massage member 30 and thus the rotary body 31 of the massage member 30 alternately rotates leftward and rightward and, accordingly, the massage projections 35 have a massage effect on the perineal region.

In particular, according to the second embodiment, the wire 34 is inserted into the massage projections 35, and thus, when the perineal region contacts the massage projections 35, the wires 34 are slightly elastically deformed and thus the massage protrusions 35 softly massage the perineal region and, accordingly, the massage effect may be further enhanced.

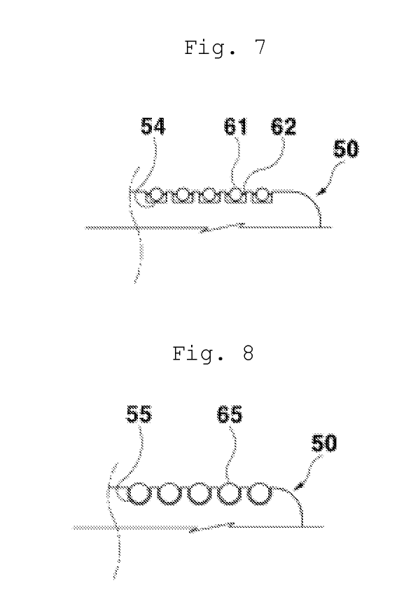

Hereinafter, a bicycle saddle according to a third embodiment of the present invention will be described with reference to FIGS. 6 and 7.

The bicycle saddle according to the first embodiment is configured such that the rotary body 21 is rotatably installed at the front end portion of the saddle main body 10 and the massage projections 25 are formed at the outer circumferential surface of the rotary body, but the bicycle saddle according to the third embodiment has a difference therefrom in that, as illustrated in FIG. 6, massage projections 61 are rotatably installed directly on a saddle main body 50 having the same shape as that of a general bicycle saddle.

In particular, the bicycle saddle according to the third embodiment includes the saddle main body 50, seating grooves 54, and massage projections 61.

The saddle main body 50 includes a buttock supporting part 51 to support left and right buttocks of a rider as in a general saddle and an extension part 52 extending from the buttock supporting part 51 to a predetermined length.

The seating grooves 54 are formed in plural in an upper surface and opposite side surfaces of the buttock supporting part 51 and the extension part 52. In this regard, the seating grooves 54 have spaces accommodating the massage projections. As illustrated in FIG. 6, the seating grooves 54 may be formed in a row, but the present invention is not limited thereto. For example, the seating grooves 54 may be irregularly dispersed.

As illustrated in FIGS. 6 and 7, the massage projections 61 have a spherical shape and are rotatable about a rotary pin 62 in a state of being accommodated in the respective seating grooves 54. In this regard, the massage projections 61 may partially protrude outside of the saddle main body 50.

Although the massage projections 61 have been described as having a spherical shape, the shape thereof is not limited thereto and the massage projections 61 may have a star shape or a triangular shape to increase stimulation of the perineal region. In addition, the massage projections 61 may have a shape in which sharp projections are formed on an outer surface of a sphere. That is, the shape of the massage projections 61 is not particularly limited so long as stimulation of the perineal region is enabled.

In such a configuration, when left and right thighs alternately move upward and downward according to pedaling movement of a bicycle in a state in which a user is seated on the saddle main body 50, the perineal region and genitals of a rider contact the massage projections 61 and, as the massage projections 61 rotate, the massage projections 61 massage the perineal region.

It has been described that the massage projections 61 are installed in an entire region of the buttock supporting part 51 and the extension part 52 of the saddle main body 50, but the present invention is not limited thereto. Although not shown in the drawings, the seating grooves 54 may be installed in an upper surface and opposite side surfaces of the extension part 52 and thus the massage projections 61 may be installed only at the extension part 52.

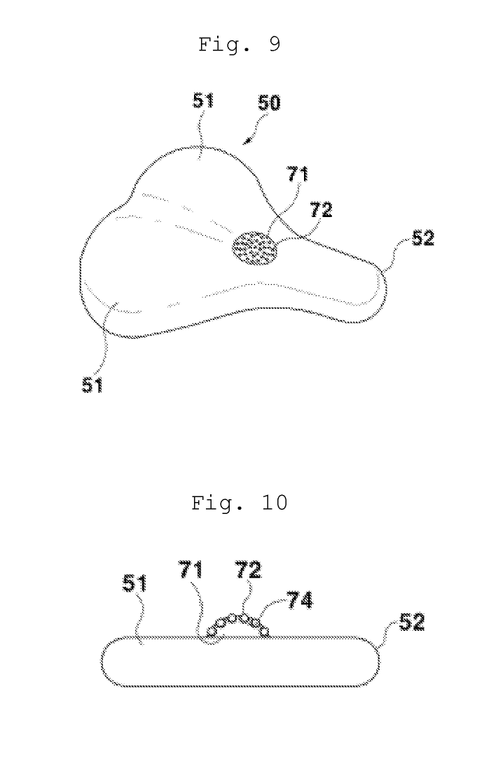

Meanwhile, the massage projections 61 illustrated in FIG. 7 are rotatable about the rotary pin 62 in a state of being accommodated in the seating grooves 54, but the present invention is not limited thereto. That is, the massage projections 61 are not rotatable about the rotary pin 62 in the seating grooves 54 and, as illustrated in FIG. 8, massage projections 65 of a ball type may rotate in a state of being accommodated in accommodation grooves 55. In this regard, as in a structure of a ball pen, the accommodation grooves 55 may have a shape that covers the massage projections 65 of a ball type, allows the massage projections 65 to rotate but does not allow the massage projections 65 to escape therefrom, and exposes portions of the massage projections 65 to the outside.

In addition, the seating grooves 52 may be formed on the saddle main body 50 in an integrated form, but the present invention is not limited thereto. A member with the seating grooves 52 formed therein may be installed at the saddle main body 50.

Hereinafter, a bicycle saddle according to a fourth embodiment of the present invention will be described with reference to FIGS. 9 and 10.

The bicycle saddles according to the first, second, and third embodiments have a configuration wherein massage projections are formed in a portion of an extension part of a saddle main body, extending forward, but the bicycle saddle according to the fourth embodiment is characterized in that, to provide women, having a perineal region positioned at a relatively rear portion as compared to men, with a more effective perineal massage effect, the saddle main body 50 is provided with a convex part 71 at a central portion thereof, and massage projections 72 are formed on the convex part 71.

The convex part 71 has a hemispherical shape with long front and rear sides, i.e., a shape of an egg cut in half. The massage projections 72 are of a ball type and, as in the installation of the massage projections 65 of the third embodiment as illustrated in FIG. 8, the massage projections 72 are inserted into the seating grooves 74 formed in the convex part 71 and rotatably installed on the seating grooves 74. However, the present invention is not limited to the above example and, as illustrated in FIG. 7, the massage projections 72 may be rotatable about a rotary pin in the seating grooves 74.

In addition, the massage projections 72 may have, in addition to a ball shape, a sharp star shape or a triangular shape to raise a degree of stimulation and may also have various other shapes so long as they enable stimulation of the perineal region and genitals.

In such a configuration, when left and right thighs alternately move upward and downward according to pedaling movement of a bicycle in a state in which a user is seated on the saddle main body 50, the convex part 71 massages the perineal region of a rider and the massage projections 61 installed on the convex part 71 stimulate the perineal region while rotating, thereby providing a massage effect thereon.

Although the present invention has been described with reference to exemplary embodiments thereof for illustrative purposes of the principle of the invention, the present invention is not limited to the configurations and effects of the embodiments set forth herein. Rather, it will be well understood by one of ordinary skill in the art that various changes and modifications may be made without departing from the spirit and scope of the invention. Therefore, all the appropriate changes and modifications and equivalents thereto should be interpreted as being within the scope of the present invention.

### INDUSTRIAL APPLICABILITY

The present invention may be applied to bicycle saddle components.

What is claimed is:

1. A bicycle saddle having perineal acupressure and massage functions and installed on indoor and outdoor bicycles, the bicycle saddle comprising:
a saddle main body to support left and right buttocks of a rider; and
a massage member rotatably installed at a front end portion of the saddle main body so as to contact a perineal region of the rider according to pedaling of the rider and thus, while rotating, stimulate the perineal region of the rider, thereby providing acupressure and massage effects thereon.

2. The bicycle saddle according to claim 1, wherein
the massage member comprises:
a rotary body provided with a rotary shaft at one side thereof and rotatably installed in a state in which the rotary shaft is inserted into the front end portion of the saddle main body; and
a plurality of massage projections protruding from an outer circumferential surface of the rotary body.

3. The bicycle saddle according to claim 1, wherein
the massage member comprises:
a rotary body provided with a rotary shaft at one side thereof, rotatably installed in a state in which the rotary shaft is inserted into the front end portion of the saddle main body, and comprising a pair of circular plates separated from each other and a connection rod connecting centers of the circular plates;
a plurality of wires connecting edges of the circular plates to each other, spaced apart from each other along circumferences thereof, and having elastic force; and
a plurality of massage projections into which the wires are inserted to be rotatable about the wires.

4. The bicycle saddle according to claim 2, wherein
the saddle main body is provided, at the front end portion thereof, with a rotary shaft hole into which the rotary shaft is inserted, and
the rotary shaft is provided, at an end thereof, with a cutting groove formed in a length direction to be divided into two branches, the end of the rotary shaft being provided, at an outer circumferential surface thereof, with an escape prevention member protruding therefrom.

5. A bicycle saddle having perineal acupressure and massage functions and installed on indoor and outdoor bicycles, the bicycle saddle comprising:
a saddle main body comprising a buttock supporting part to support left and right buttocks of a rider and an extension part extending from a front end of the buttock support part; a plurality of seating grooves in the saddle main body; and
massage projections accommodated and rotatably installed in the seating grooves and partially protruding from the saddle main body so as to contact a perineal region of the rider according to pedaling of the rider and thus, while rotating, stimulate the perineal region of the rider, thereby providing a massage effect thereon.

6. The bicycle saddle according to claim 5, wherein
the massage projections are rotatable about a rotary pin installed in the seating grooves.

7. The bicycle saddle according to claim 5, wherein
the massage projections are formed as ball members having a spherical shape and rotatably installed in a state of being accommodated in the seating grooves.

8. A bicycle saddle having perineal acupressure and massage functions and installed on indoor and outdoor bicycles, the bicycle saddle comprising:
a saddle main body comprising a buttock supporting part to support left and right buttocks of a rider and an extension part extending from a front end of the buttock support part; a convex part disposed at a central portion of the saddle main body to protrude therefrom and having a hemispherical shape; a plurality of seating grooves formed in the convex part; and
massage projections accommodated and rotatably installed in the seating grooves and partially protruding from the extension part so as to contact a perineal region of the rider according to pedaling of the rider and thus, while rotating, stimulate the perineal region of the rider, thereby providing a massage effect thereon.

9. The bicycle saddle according to claim 2, wherein
the massage projections have any one shape selected from a circular shape, a star shape, and a triangular shape.

10. The bicycle saddle according to claim 5, wherein
the massage projections have any one shape selected from a circular shape, a star shape, and a triangular shape.

11. The bicycle saddle according to any one of claim 8, wherein
the massage projections have any one shape selected from a circular shape, a star shape, and a triangular shape.
